(19) United States
(12) Patent Application Publication
(10) Pub. No.: US 2013/0252240 A1
(43) Pub. Date: Sep. 26, 2013

(54) CRYOEMBEDDED CELL CONCENTRATES, METHODS FOR MAKING, AND METHODS FOR USING

(71) Applicant: VENTANA MEDICAL SYSTEMS, INC., Tucson, AZ (US)

(72) Inventors: Anne Cutler, Tucson, AZ (US); Suneeti Mané, Oro Valley, AZ (US); Scott Cockayne, Oro Valley, AZ (US); Scott Gill, Tucson, AZ (US); Ryan Noreen, Tucson, AZ (US); Eileen Margaritov, Tucson, AZ (US); Janet Liddell, Tucson, AZ (US); Olivia Herman, Tucson, AZ (US)

(73) Assignee: VENTANA MEDICAL SYSTEMS, INC., Tucson, AZ (US)

(21) Appl. No.: 13/773,668

(22) Filed: Feb. 22, 2013

Related U.S. Application Data
(60) Provisional application No. 61/613,666, filed on Mar. 21, 2012.

(51) Int. Cl. G01N 1/30

(52) U.S. Cl. CPC G01N 1/30
USPC 435/6.11; 435/366; 435/372; 435/40.5; 435/7.1

(57) ABSTRACT

Methods for preparing a cryoembedded cell concentrate are disclosed. The cryoembedded cell concentrate can be sectioned for use in methods (e.g., immunohistochemistry assays, immunocytochemistry assays, methods that use light or fluorescent microscopy, in situ hybridization assays, or diagnostic methods). Also disclosed are kits comprising cryoembedded cell concentrates.

### CROSS-REFERENCE TO RELATED APPLICATIONS

This application claims the benefit of U.S. Provisional Application No. 61/613,666, filed Mar. 21, 2012, entitled “METHODS OF GENERATING A TISSUE SUBSTITUTE FROM CELL PELLETS AND USE THEREOF” which is herein incorporated by reference in its entirety.

### BACKGROUND

The diagnosis of disease based on the interpretation of tissue or cell samples taken from a diseased organism has expanded dramatically over the years. In addition to histological staining techniques and immunohistochemical assays, in situ techniques, such as in situ hybridization and in situ polymerase chain reaction, are now used to help diagnose disease states in humans. Thus, there are many varieties of techniques that can assess not only cell morphology, but also the presence of specific macromolecules within cells and tissues.

Some of these techniques may use sample cells or tissues undergo preparatory procedures that may include fixing the sample with chemicals such as formaldehyde or glutaraldehyde, formalin substitutes, alcohols (such as ethanol, methanol, isopropanol) or embedding the sample in inert materials such as paraffin, celloidin, agars, polymers, resins, cryogenic media or a variety of plastic embedding media. Other sample tissue or cell preparations may use physical manipulation such as freezing or aspiration through a fine needle. Some methods have been developed for embedding tissue samples, either for paraffin embedded sections or for cryoembedded frozen sections (LIM et al., “Boric acid-enhanced embedding medium for cryomicrotomy” Acta Histochem. (May 2012) Vol. 114, No. 3, pp. 296-299; COLEMAN et al., “A protocol for cryoembedding the adult guinea pig cochlea for fluorescence immunohistology” J. Neurosci. Methods (2009) Vol. 176, pp. 144-151; STEINBRECHT et al., “A cryoembedding method for cutting ultrathin cryosections from small frozen specimens” J. Microsc. (October 1984) Vol. 136, Pt. 1, pp. 69-75). Some methods have been developed to embedded cells in paraffin (RHODES et al, “Evaluation of HER-2/neu Immunohistoehemical Assay Sensitivity and Scoring on Formalin-Fixed and Paraflin-Processed Cell Lines and Breast Tumors—A Comparative Study Involving Results From Laboratories in 21 Countries” Am. J. Clin. Pathol. (2002) Vol. 118, pp. 408-417). Regardless of the tissue or cell sample or its method of preparation or preservation, one goal of the technologist can sometimes be to obtain accurate, readable, and reproducible results that permit the accurate interpretation of the data. One way to provide accurate, readable and reproducible data is to prepare the tissue or cells in a fashion that optimizes the results of the test regardless of the technique employed. In the case of immunohistochemistry and in situ techniques this can mean increasing the amount of signal obtained utilizing a specific probe (e.g., antibody, DNA, RNA, etc.).

There are a variety of non-formalin methods for preserving and preparing cytological and histological samples. Examples of these methods include air-drying, alcoholic fixation, spray fixatives and storage mediums such as sucrose/glycerin; tissues and cells (either fixed or unfixed) may be frozen and subsequently subjected to various stabilizing techniques which include preservation, fixation, and desiccation; or tissues and cells may be stabilized in a number of non-cross-linking aldehyde fixatives, non-aldehyde containing fixatives, alcoholic fixatives, oxidizing agents, heavy metal fixatives, organic acids and transport media.

Immunostaining and in situ DNA analysis can be useful tools in histological diagnosis and the study of tissue morphology. Immunostaining can rely on the specific binding affinity of antibodies with epitopes in tissue samples, and the increasing availability of antibodies which bind specifically with unique epitopes which are sometimes present only in certain types of diseased cellular tissue. Immunostaining may sometimes require a series of treatment steps conducted on a tissue section mounted on a glass slide to selectively highlight certain morphological indicators of disease states. In some instances, treatment steps can include pretreatment of the tissue section to reduce non-specific binding, antibody treatment and incubation, enzyme labeled secondary antibody treatment and incubation, substrate reaction with the enzyme and counterstain. The result can produce fluorescent or chromogenic highlighted areas of the tissue section having epitopes binding with the antibody. In some instances, in situ DNA analysis relies upon the specific binding affinity of probes with nucleotide sequences in cell or tissue samples.

Immunohistochemistry (IHC) or immunocytochemistry (ICC) can include the visualization of a tissue or cellular component in situ by detecting specific antibody-antigen interactions where the antibody has been tagged with a visible marker. IHC can be the detection of antigens in tissues, while ICC can be the detection of antigens in or on cultured cells (JAVOIS, Methods in Molecular Medicine, V. 115: Immunocytochemical Methods and Protocols, 2nd edition, (1999) Humana Press, Totowa, N.J.). The visible marker may be a fluorescent dye, colloidal metal, hapten, radioactive marker or an enzyme. The tissue or cells may be frozen, paraffin-fixed, or resin-embedded samples. Regardless of the method of preparation, maximal signal strength with minimal background or non-specific staining can be desirable to give optimal antigen visualization.

In some of these techniques, an antibody can link a cellular antigen to a visible marker that can be readily visualized with a microscope. For both IHC and ICC, there may be a wide range of specimen sources, broad antigen availability, differing antigen-antibody affinity, varying antibody types, and several detection enhancement methods.

Some antibody products (e.g., anti-complement antibodies) used in the screening of various diseases or cancers may require testing to verify affinity and/or other quantifiable aspects of the antibody to be marketed. This testing can utilize specific tissues having known antigen markers. For example, lupus kidney tissue, which is positive for various complement components, such as C1q, C3, and/or C4, can be used for testing anti-complement antibodies because it can exhibit high levels of these markers, especially when the tissue is in a “flare” state.

However, the availability of such tissue can be very limited and may be extremely expensive. In addition, the vendors providing such tissue often do not prequalify the tissue as being complement antigen “positive”, nor do they guarantee a lupus “flare” state. This places many companies at risk in their quality control testing.

Thus, there is a long felt need in the industry for a reliable, consistent and inexpensive source of antigen for the testing of antibody products; some of the embodiments of this invention meet this long felt need. Some embodiments of the present invention provide a method for preparing a tissue substitute from a cell concentrate that provides a consistent source of a target (e.g., an antigen or an antibody target) for testing antibody products. In some instances, this cell concentrate can provide cell-cell contact, structure and physiology, sometimes allowing for antibody detection consistent with a tissue.

### SUMMARY

Some embodiments of the invention include methods of preparing a cryoembedded cell concentrate, the method comprising: washing cultured cells one or more times with a one or more wash solutions; removing substantially all of the extracellular fluid, to provide a cell concentrate; freezing the cell concentrate; cryoembedding the frozen cell concentrate in an embedding medium, to provide the cryoembedded cell concentrate; and optionally curing the cryoembedded cell concentrate. In certain embodiments, the ultrastructure and target specificity of the cells in the cryoembedded cell concentrate are substantially maintained compared to the cultured cells. Other embodiments include a cryoembedded cell concentrate prepared as described above and sections made from cryoembedded cell concentrate prepared as described above.

Some embodiments of the invention include methods for using a section of a cryoembedded cell concentrate prepared as described above where the method comprises detecting ultrastructure, target specificity, or both, of the cells in the section. For example, the detecting can be accomplished using an immunocytochemical technique, using an immunohistochemical technique, using a hybridization technique, using a staining technique, or using an antibody to target a non-antigen. In certain embodiments, the method comprising detecting ultrastructure, target specificity, or both, of the cells in the section is part of a diagnostic method for detecting disease in an animal.

In other embodiments of the invention kits comprising a cryoembedded cell concentrate prepared as described above are included. The kit, in some instances can comprise one or more of a reagent for detection, a stain, and a control sample for the cryoembedded cell concentrate.

### BRIEF DESCRIPTION OF THE DRAWINGS

FIG. 1-Cryoembedded Human Kidney (glomeruli with surrounding tubules) diagnosed with Systemic Lupus Erythematosus (SLE) stained with FITC anti-C1q. FITC is a green fluorescent marker that is bound to anti-C1q. The color image displays green where there is C1q specificity. Human kidney diagnosed with SLE was used as a model, as a fluorescent intensity reference. The magnification is 20×.

FIG. 2-Cryoembedded RAJI cell pellet stained with FITC anti-C1q. This is a representative image and displays C1q specificity, intact ultrastructure (e.g., morphology) and cell/cell contact. The section is 2-3 cell layers thick and not simply a monolayer. The magnification is 20×.

### DETAILED DESCRIPTION

Some embodiments of the invention include methods for cryoembedding cultured cells. Some embodiments include methods for preparing cultured cells to provide a cryoembedded tissue substitute for use in diagnostic methods such as immunological-based methods or hybridization-based methods. Such a tissue substitute can provide a reliable, inexpensive source of material for quality control validation (e.g., as may be used by the industry to meet testing standards for antibody products). Some embodiments of the invention address a long felt need for a tissue substitute because tissue sources can be limited and/or cost prohibitive. Some embodiments of the invention provide a suitable procedure to make cryoembed cultured cells for use in diagnostic methods (e.g., ICC/IHC and in situ hybridization).

Cultured cells can be a useful alternative to tissue because they do not rely on a donor, can be easy to grow, can be immortal, and may constitutively express antigen. Cultured cells may be advantageous because they may eliminate target (e.g., antigen, epitopes targets for antibodies, DNA, or RNA) heterogeneity issues found in some tissues; cultured cells can be homogeneous in expression. Some embodiments of the present invention provide cultured cells suitable for cryoembedding and subsequent sectioning for detection of targets.

Cell concentrates can be used to prepare cryoembedded cell concentrates. Cell concentrates can be used to prepare cryoembedded cell concentrates. A cell concentrate can be any form of suitably concentrated cells, such as a cell pellet (e.g., from centrifugation) or cells concentrated by filtration.

Some embodiments of the cryoembedded cell concentrate substantially maintain one or more of viability, target specificity (e.g., antigen, epitopes targets for antibodies, DNA, or RNA) and ultrastructure (e.g., cell morphology). Viability of the cells can be determined by any suitable method including, for example, flow cytometry, Biacore, MTT (3-[4,5-dimethylthiazol-2-yl]-2,5-diphenyltetrazolium bromide; thiazolyl blue) cell viability assays, trypan blue dye exclusion assays, assays using propidium iodide, and assays using fluorescein diacetate. Substantially maintaining viability means that more than about 90% of the cells remain viable in the cryoembedded cell concentrate. In some embodiments, more than about 92% (or more than about 95%, or more than about 98%, or more than about 99%) of the cells in the cryoembedded cell concentrate remain viable as compared to the cultured cells used to prepare the cell concentrate. Ultrastructure of cells can be determined by any suitable method such as visual inspection, flow cytometry, or Biacore. Substantially maintaining ultrastructure of cells means that more than about 90% of the cells in the cryoembedded cell concentrate retained ultrastructure as compared to the cultured cells used to prepare the cell concentrate. In some embodiments, more than about 92% (or more than about 95%, or more than about 98%, or more than about 99%) of the cells in the cryoembedded cell concentrate retained ultrastructure as compared to the cultured cells used to prepare the cell concentrate.

Target specificity can be determined using any suitable method such as, an immunocytochemical technique, an immunohistochemical technique, a hybridization technique (e.g., in situ hybridization), a staining technique, using an antibody to target a non-antigen (e.g., using an antibody to target components of complement), flow cytometry, Biacore, or Western blot analysis. Substantially maintaining target specificity can depend on that type of target and can mean that more than about 70% (or more than about 80%, or more than about 90%, or more than about 95%, or more than about 98%) of the target specificity is maintained in the cryoembedded cell concentrate. In some embodiments, where target specificity is specificity of antibody binding (e.g., to an antigen, to an epitope, or to a non-antigen) an analysis of the extent of binding can be compared. In some embodiments, where target specificity is specificity of hybridization (e.g., in situ hybridization) an analysis of the extent of hybridization can be compared.

### Preparation of Cryoembedded Cell Concentrates—Some Embodiments of Cell Growth

Any suitable cell line may be used to prepare cultured cells employed in the cryoembedded cell concentrate. The cell can be from an animal including but are not limited to canine, bovine, porcine, avian, mammalian, and human. The cell can be a eukaryotic cell which can include but is not limited to fungi, yeast, insect cells (e.g., Spodoptera frugiperda (SF9)), animal cells such as CHO and mouse cells (e.g., Lewis lung carcinoma cells, B16F10 melanoma cells, and TC-1 cervical carcinoma cells), African green monkey cells (such as COS 1, COS 7, BSC 1, BSC 40, and BMT 10), and human cells (e.g., human carcinoma cells, DU145 cells, PC-3 cells, RWPE-1 cells, LNCaP, A375 cells, HeLa cells, SK-MEL-28 cells, tGM24 cells, GM0637 cells, HS27 cells, MCF₇ cells, MDA-MB-231 cells, A549 cells, THP-1 cells, and 300.19 cells), as well as plant cells. In some embodiments, cells can include, but are not limited to RAJI (e.g., ATCC # CCL-86, a lymphoblast-like cell derived from a Burkitt's lymphoma patient), Her-2 positive cell lines (e.g., ATCC # CRL-2351), MSH2 positive cell lines (e.g., SKOV3.A2), DU145 (prostate cancer), Lncap (prostate cancer), MCF-7 (breast cancer), MDA-MB-438 (breast cancer), T47D (breast cancer), THP-1 (acute myeloid leukemia), U87 (glioblastoma), SHSYSY Human neuroblastoma cells (cloned from a myeloma), and Saos-2 cells (bone cancer). In certain embodiments, the cell line can be chosen according to the antigen to be detected. Of course, the cell may be transfected with one or more genes.

The term “cultured cells” includes cells that were at one time grown in any suitable in vitro or engineered manner. For example, “cultured cells” include cells that were grown and then harvested while being sustained (e.g., alive but were not dividing or fully functional). “Cultured cells” also include cells that were harvested during exponential growth, or any growth phase. Cells may be grown according to any protocol (e.g., those used for that particular cell or cell line) and/or any culture media may be used for the chosen cell line (e.g., media used for that particular cell or cell line). Cells can be grown and maintained at an appropriate temperature and gas mixture (e.g., about 37° C. and about 5% CO₂ for mammalian cells) in a cell incubator. Culture conditions can vary widely for each cell type, and variation of conditions for a particular cell type can result in different phenotypes being expressed.

Another factor in culture systems is the growth medium. Recipes for growth media can vary in pH, glucose concentration, growth factors, and the presence of other nutrients. The growth factors used to supplement media can be derived from animal blood, such as calf serum. In some instances, these blood-derived ingredients are a potential for contamination of the culture with viruses or prions, particularly in medical biotechnology applications; sometimes it can be useful to minimize or eliminate the use of these blood-derived ingredients. Chemically defined media can be used in some instances. One example of a cell culture medium is Dulbecco's Modified Eagle Medium (DMEM) which can support the growth of a variety of mammalian cell lines. In additional embodiments, certain growth factors may be added to induce antigen expression or presentation. In alternative embodiments, the media may be depleted for a certain factor resulting in a specific pathway of expression; for example, in some cells (e.g., RAJI cells) depleting a human serum based media of complement C6 can, in some instances, drive the complement expression specific to the classical pathway of activation of the complement system.

In some instances, cell density (the number of cells per volume of culture medium) can influence some cell properties, such as, growth and antigen expression. For example, a lower cell density can make granulosa cells exhibit estrogen production, while a higher cell density can make granulosa cells appear as progesterone-producing theca lutein cells.

In the present inventions, cultured cells can be grown in many different types of cultures, including, for example, in suspension or as adherent cultures. Some cells naturally live in suspension, without being attached to a surface, such as cells that exist in the bloodstream. There are also cell lines that have been modified to be able to survive in suspension cultures so they can be grown to a higher density than adherent conditions would allow. Adherent cells can require a surface, such as tissue culture plastic or microcarrier, which may be coated with extracellular matrix components to increase adhesion properties and provide other signals needed for growth and differentiation. Some cells derived from solid tissues can be adherent. Another type of adherent culture is a 3-D culture system (e.g., an organotypic culture), which involves growing cells in a three-dimensional (3-D) environment as opposed to two-dimensional culture dishes. This 3-D culture system can, in some instances, be biochemically and/or physiologically more similar to in vivo tissue as compared to two dimensional cultures.

### Preparation of Cryoembedded Cell Concentrates—Some Embodiments of Washing Cultured Cells and Removing Wash Solution

Embodiments for some methods of preparing the cryoembedded cell concentrate include washing the cultured cells one or more times with one or more wash solutions. Washing can occur by any suitable technique or set of suitable steps, and can include, for example, isolating or partially isolating cells from surrounding solution, removing the excess solution (e.g., supernatant or a solution that does not include a high density of cells compared to the isolated or partially isolated cell portion) after the isolation or partial isolation (if needed), and resuspending the cells in a wash solution (which can be the same or different from a prior used wash solution). Techniques for isolating or partially isolating the cells from the surrounding solution include any suitable technique, such as centrifugation or filtration. Centrifugation can occur by spinning the cultured cell solution at any suitable speed, such as from about 100 g to about 300 g, from about 128 g to about 207 g, about 207 g, or about 286 g. Removing the excess solution (e.g., supernatant) can be accomplished by any suitable technique such as, pipetting (e.g., with a glass pipets or a micropipette), decanting, aspiration, or toweling. Resuspending the cells can be accomplished by any suitable technique such as, vortexing or repeated pipetting. The washing steps can each use the same wash solution or can use different wash solutions. In some embodiments, the last wash solution is different from the previous wash solutions, where the previous wash solutions were the same.

A wash solution can include any suitable solution, such as PBS (phosphate buffered saline), saline, and serum-free media (e.g., RPMI Medium 1640, Gibeo #21870, DMEM).

After washing the cultured cells, substantially all of the extracellular fluid is removed from the cultured cells to provide a cell concentrate. In certain embodiments, removal can be accomplished by isolating or partially isolating the cells by any suitable techniques, such as centrifugation or filtration. Centrifugation can occur by spinning the cultured cell solution at any suitable speed, such as from about 250 g to about 400 g, from about 300 g to about 350 g, about 335 g, or about 380 g. In some embodiments, the centrifugation speed is chosen to avoid undue sheer stress. Removal of the excess solution (e.g., supernatant) after centrifugation can be accomplished by any suitable technique such as, pipetting (e.g., with a glass pipets or a micropipette), decanting, aspiration, or toweling. Removal of substantially all of the extracellular fluid can, in some instances, be accomplished by filtration, or, if needed, further removal of solution (e.g., supernatant) can be accomplished by any suitable technique such as, pipetting (e.g., with a glass pipets or a micropipette), decanting, aspiration, or toweling. The term “removing substantially all of the extra-cellular fluid” means that most or all of the visible extracellular fluid (e.g., fluid that does not have any cells, or fluid that has cells at a lower cell density than the isolated or partially isolated cell portion) is removed. In still other embodiments, it can be desirable to have some (or significant) cell-to-cell contact in the cell concentrate and/or in the cryoembedded cell concentrate; in some instances, it can also be desirable that this cell-to-cell contact mimic some aspects of tissue (e.g., a physiological milieu), thereby providing a suitable tissue substitute.

In some instances, it is desirable for the cryoembedded cell concentrate to avoid unwanted properties (e.g., bubbles, lower than desired antigenicity, damaged ultrastructure). For example, if a sufficient amount of liquid is not removed from the cell concentrate, then the freezing process may, under certain circumstances, cause the embedding medium to detach itself away from the cell concentrate, leaving “holes” in the frozen cell concentrate where bubbles formed in the frozen block. This can jeopardize block integrity making it difficult to obtain quality sections. In addition, the destruction caused by these holes may compromise antigenicity and ultrastructure. In certain embodiments, a faster freezing time can reduce or alleviate some problems caused by an insufficient amount of liquid removal.

### Preparation of Cryoembedded Cell Concentrates—Some Embodiments of Freezing the Cell Concentrate

The cell concentrate can be frozen. In certain embodiments, the sample can be frozen to a temperature of about −70° C. to about −200° C., about −100° C. to about −200° C., about −140° C. to about −200° C., about −78° C., about −150° C., or about −190° C. This freezing can be accomplished using any suitable technique, such as a dry ice/ethanol bath, liquid nitrogen, or an isopentane bath cooled by liquid nitrogen. In some instances, the cell concentrate can be frozen within a short period of time (e.g., less than about 5 minutes, less than about 2 minutes, or less than about 1 minute) which may, in some instances, include flash freezing. In some embodiments the cryoembedded cell concentrate made from a cell concentrate that was the flash frozen can retain ultrastructure, target specificity, and viability. In some embodiments, the cryoembedded cell concentrate made from the cell concentrate can have undesirable properties (e.g., bubbles, lower than desired target specificity, damaged ultrastructure) if not enough of the extracellular fluid is removed and/or if the freezing does not occur fast enough (e.g., to prevent ice crystal formation).

Frozen cell concentrates can be stored using any suitable method such as, by wrapping in foil and then maintaining the wrapped frozen cell concentrates at about −80° C.

### Preparation of Cryoembedded Cell Concentrates—Some Embodiments of Cryoembedding and Sections Thereof

Some embodiments include cryoembedding the cell concentrate. Any suitable method can be used to cryoembed the cells, such as placing the frozen cell concentrate in a mold (e.g., cryomold) and covering with an embedding medium. Any suitable medium can be used, such as O.C.T. Compound (TISSUE TEK® Cat. #4583), CryO-Z-T (PELCO), Tissue Freezing Medium (TBS), Histo/Cyto-Freeze Cryo Spray (PELCO), M1 (Lipshaw), or any embedding medium suitable for preserving cells or tissue. O.C.T. Compound (also referred to as OCT) is comprised of a mixture of glycols and light resins; OCT can provide a quality specimen matrix and/or may leave no residue, thereby reducing non-specific staining.

The mold (e.g., cryomold) can then be cooled to freeze the cryoembedded cell concentrate; for example, the mold can be placed in a cryostat chamber having a thermoelectric cooling device, such as a Leica CM 1850, allowing heat extraction of the cryoembedded cell concentrate.

Once embedded, the mold containing the cryoembedded cell concentrate can be cured by any suitable method such as placing the mold at about −80° C. (or from about −70° C. to about −90° C.) for period of time (e.g., about 2 days, about 3 days, about 4 days, or longer). In some instances, the mold containing the cryoembedded cell concentrate is wrapped in foil prior to placing the mold at about −80° C.

The cryoembedded cell concentrate can be stored for long periods of time (e.g., from about 5 years to about 10 years, more than about 5 years, or about 5 years), as desired.

In some embodiments, frozen sections can be cut from the cryoembedded cell concentrate. For example, sections can be cut using any suitable technique, such as a cryostat. The thickness of the sections can be any suitable thickness, such as from about 1 micron to about 10 microns, from 2 microns to about 5 microns, about 2 microns, about 3 microns, about 4 microns, or about 5 microns. The sections can, in some instances, be (a) desiccated, (b) air dried, or (c) fixed; these actions can take place prior to subsequent staining or storage. Any suitable fixative can be used in (c), including, but not limited to, acetone, methanol, ethanol, and methylated spirits. In other embodiments, the choice of fixative or the absence thereof can depend on the specific cell line and antigen to be detected. In certain instances (e.g., with highly sensitive epitopes), the absence of a fixative can be desired.

In certain instances, two types of cryostat sections can be used (1) Fresh, or unfixed sections where quickly frozen (e.g., snap frozen) cryoembedded cell concentrates are first cut, then either air-dried or fixed prior to staining and (2) frozen cryoembedded cell concentrates, where the sample is first fixed then cryoprotected to stabilize (e.g., with sucrose or other stabilizer) the cell structure prior to freezing and sectioning. Some advantages of frozen sections are that they allow antigen preservation, they can be faster to perform, and they offer flexibility, since a choice of several fixatives can be used, thereby facilitating the optimization of fixative for each antigen.

In some instances, it can be desirable for the cell-cell milieu in the cryoembedded cell concentrate be similar to a frozen tissue section, thus creating a tissue substitute that mimics the physiology of a tissue section, whereas cells that are isolated may not have sufficient cell-to-cell contact to simulate tissue architecture. In additional embodiments, cells can be chosen that express or possess a desired target (e.g., antigens, antibody targets, DNA targets, and RNA targets) so that a physiology similar to the tissue being replaced or tested can be mimicked.

### Some Methods for Using the Cryoembedded Cell Concentrate

There are many uses for the cryoembedded cell concentrates or sections thereof. In certain embodiments, cryoembedded cell concentrates or sections thereof can be used in diagnostic methods to, for example, determine the presence or absence of disease indicators (e.g., targets such as antigens, antibody targets, DNA targets, and RNA targets). In other embodiments, cryoembedded cell concentrates or sections thereof can be used to develop new antibody assays and can reduce the dependence on rare tissue samples for that development. In still other embodiments, cryoembedded cell concentrates or sections thereof can be used for making standardized control slides or cell blocks for testing. In some instances, cryoembedded cell concentrates or sections thereof can be used to provide a visual confirmation for a quantitative assay.

In certain embodiments of the invention, cryoembedded cell concentrates or sections thereof can be used in a method (e.g., a diagnostic method) that employs an immunological (e.g., antigen) based assay, such as IHC-based or ICC-based assays. Certain embodiments of the method can be optimized for any culture cell for ICC. Some embodiments include use in an IHC-based manner (e.g., chromogenic, fluorescent, hapten, or enzyme). In other embodiments, cryoembedded cell concentrates or sections thereof are made from cell concentrates that in some instances create cell-to-cell contact that can mimic the matrix of a tissue section.

Some embodiments can provide an alternative to cytospins (unfixed cultured cells spun on microscope slides). Cytospins can be beneficial for quick stains, but, because the cells are not fixed or frozen as a matrix, they typically do not survive most long antibody/antigen IHC or ICC assay washings and/or incubations. In some embodiments, the cryoembedded cell concentrate (and sections made therefrom) can survive lengthy procedures (e.g., long antibody/antigen IHC or ICC assay washings/incubations).

Other embodiments of the invention include using this method with any cell line displaying any antigen with any ICC protocol.

In some instances, ICC protocols or modified IHC protocols can be used; labeling can occur using a primary antibody or a secondary antibody to detect the primary antibody/antigen complex. In certain instances, the primary antibody may be directly labeled with an enzyme (e.g., horseradish peroxidase or alkaline phosphatase), a fluorophore (e.g., FITC or rhodamine), or quantum dots (e.g., Qdot® nanocrystals from Life Technologies). When used with a secondary antibody detection scheme, the secondary antibody can be generated against the immunoglobulins of the primary antibody source (e.g., if the primary antibody is raised in rabbit, then the secondary antibody will be an anti-rabbit antibody). In some embodiments, the optimal titer of both the primary and secondary antibody can be determined for each batch.

There are many factors that can be optimized for antibody dilution, including, but not limited to, the amount of antibody used. In certain circumstances, the antibody dilution chosen will give a strong specific antigen staining and/or will have a low non-specific background. The secondary antibody dilution can be optimized, if desired.

Any detection method can used including, but not limited to those that use fluorochromes and chromogens (e.g., enzyme mediated). Any suitable substrate for conversion by an enzyme can be used; in some instances the substrate can yield a precipitating product. Some substrates include, but are not limited to Diaminobenzidine (DAB), 3-Amino-9-ethylcarbazole (AEC), and Naphthol fast Red TR.

In some instances when using fluorochromes, a fluorescent molecule may be attached to the antibody for detection using UV light. Any suitable fluorescent molecule can be used, including but are not limited to, Fluorescein, Rhodamine, R-Phycoerythrin (PE), Texas Red®, Cy3 and Cy5 (Qdot® nanocrystals).

In certain circumstances, “anti-fading” solutions (e.g., DABCO) can be added to the mounting medium, to prolong the viewing time of the sample. Any suitable fluorescence mounting fluids, mounting media, counterstain solution, anti-staining solutions, or combination thereof can be used.

Some embodiments of the present invention include a method to detect complement components anti-C1q, anti-C3, and anti-C4. Quantitation and visualization of complement components can sometimes present a challenge because detection is not a direct antigen/antibody staining assays but rather through the creation of an immune complex. Complement component characterization utilizing RAJI cells has been described (e.g., HUTTEROTH et al., “Detection of circulating immune complexes with a modified Raji cell technique” Klin Wochenschr. (Sep. 15, 1977) Vol. 55, No. 18, pp. 899-901; COOPER, N. R., “Methods to detect and quantitate complement activation” Springer Semin Immunopathol. (1983) Vol. 6, Nos. 2-3, pp. 195-212; ERDEI et al., “Characterization of C1q-binding material released from the membranes of Raji and U937 cells by limited proteolysis with trypsin” Biochem. J. (1988) Vol. 255, pp. 493-499; BOKISCH et al., “Receptor for the fourth component of complement on human B lymphocytes and cultured human lymphoblastoid cells” J. of Exp. Med. (1974) Vol. 140, pp. 1336-1347).

Lupus kidney (disease state “flare”) can be an effective tissue type to analyze complement components in immunohistochemistry (IHC). This tissue and disease state can be used for anti-complement antibody testing, because, in some preparations, the complement component expression is high enough for fluorescent intensity to meet acceptable staining criteria. However, this tissue can be hard to obtain, complement expression can be hetergeneous, and complement expression can be limited to small areas of tissue. Some embodiments of the present invention can overcome one or more of these problems. For example, certain embodiments use cryoembedded RAJI cell concentrate sections prepared as described herein.

In some embodiments where complement component analysis is desired, any cell type that possess receptors for complement components can be used. For example, RAJI cells (ATCC number CCL-86) a lymphoblast-like cell derived from a Burkitt's lymphoma patient, can be used. RAJI cells can possess numerous receptors for complement components (including C1q, C3, and C4) and therefore, can, in some instances, be used in the detection of immune complexes.

Some embodiments of the present invention include staining methods that allow complement component detection via the immune complex (e.g., by fluorescent visibility), as described in this paragraph. Complement activity is not antigen sensitive, but can be triggered by specific antigens. Some staining methods employ detection of the immune complex (complement component plus receptor) released from the membrane in an in vitro scenario. The cryoembedded cell concentrate allows for this reaction to take place on a RAJI cryosection, on a slide in an immunohistochemical fashion. C6-depleted sera is used to allow binding to the complement receptors, creating an immune complex (e.g., using antibodies that target complement components). C6 is a component of the alternative pathway and it's depletion can render this staining assay specific for the classical pathway of activation of the complement system, thereby allowing for the detection of C1q, C3, and C4 on the immune complex.

In some embodiments, methods for using cryoembedded cell concentrates (or sections thereof) can include hybridization-type methods. For example, in situ hybridization (ISH) can be employed as a molecular technique to localize DNA sequences on human chromosomes (BAUMAN, “Fluorescence microscopical hybridocytochemistry” Acta Histochem Suppl. (1985) Vol. 31, pp. 9-18; PINKEL et al., “Cytogenetic analysis using quantitative, high-sensitivity, fluorescence hybridization” Proc Natl Acad Sci USA. (May 1986) Vol. 83, No. 9, pp. 2934-2938). Also, refinement of various aspects of the fluorescence in situ hybridization (FISH) technique has advanced the field of human cytogenetics and molecular diagnostics, allowing, in some instances, for the identification of chromosomal abnormalities associated with solid tumors and hematopoietic malignancies, and for the diagnosis of infectious diseases. (HEIM et al., Cancer Cytogenetics, 2nd edition (1995) Wiley-Liss, New York; Klinger 1995; TIMM et al., “Amplification and detection of a Y-chromosome DNA sequence by fluorescence in situ polymerase chain reaction and flow cytometry using cells in suspension” Cytometry (Sep. 15, 1995) Vol. 22, No. 3, pp. 250-255; HESELMEYER et al., “Advanced-stage cervical carcinomas are defined by a recurrent pattern of chromosomal aberrations revealing high genetic instability and a consistent gain of chromosome arm 3q” Genes Chromosomes Cancer. (August 1997) Vol. 19, No. 4, pp. 233-240; SAUER et al., “Assessment of HER-2/neu overexpression and/or gene amplification in breast carcinomas: should in situ hybridization be the method of choice?” APMIS (March 2003) Vol. 111, No. 3, pp. 444-450).

In certain instances, the first step in the ISH process can be to make a fluorescent copy of the probe sequence (FISH) or a modified copy of the probe sequence. Before hybridization, both the target and the probe sequences are denatured with heat or chemicals. The probe and target sequences are then combined and the probe can hybridize to its complementary sequence on the target (e.g., by forming hydrogen bonds). If the probe is already fluorescent, it can be possible to detect the site of hybridization directly. In other cases, an additional step may be needed to visualize the hybridized probe. Hybrids formed between the probes and their chromosomal targets can be detected using a fluorescent microscope (e.g., O'CONNOR, “Fluorescence in situ hybridization (FISH)” Nature Education (2008) Vol. 1, No. 1)

In some instances, several factors are considered (e.g., adjusted or optimized, as desired) when using a fluorescent microscope. These factors can include, but are not limited to, sensitivity, resolution, size of the target DNA/RNA sequence, size of the target DNA/RNA, and conformation of the DNA within the chromosome (e.g., metaphase chromosomes, interphase chromosomes, or naked DNA).

Some embodiments of the present invention include the use of the cryoembedded cell concentrate for use in ISH techniques and as an alternative to paraffin embedded tissue samples.

### Signal Amplification

In some embodiments, it may be advantageous to amplify the signal to be detected, as signal amplification techniques can be used in many instances, such as for enhancing the sensitivity of immunocytochemical methods. Signal amplification methods can, in some instances be used in conjugation with any of the techniques described herein, as desired. Signals amplification can occur by any suitable method, including but not limited to using poly-conjugated secondary antibodies, Avidin-Biotin interactions, or other commercially available amplifiers (e.g., tyramide catalyzed systems). In some instances, washing and antibody titration can be used to minimized non-specific signals.

### Kits and Systems

In some embodiments, the present invention provides kits comprising at least one cryoembedded cell concentrate prepared as disclosed herein, reagents for detection (e.g., labeled specific binding agents and/or chromogenic compounds), and one or more stains (e.g., Alician Blue, Trichrome, Hematoxylin, and Eosin). In some embodiments, the kit also includes instructions for use.

The kit can optionally further include control slides for assessing detection and signal of the antibody or probe.

### EXAMPLES

### Example 1

### Growth and Preparation of Cells

This example provides conditions for several different cell lines utilized in the preparation of a cryoembedded cell pellet. Cultures were split at 2-3 day intervals based on individual cell line growth curves.

The RAJI cell line RAJI-CCL-86, an MSH2 positive cell, and a Her-2 positive cell line (ATCC# CRL-2351) were all maintained in RPMI Medium 1640 (GIBCO #21870)+10% FBS (GIBCO #10082-147)+2 mM L-Glutamine+100 units/ml penicillin+100 μg/ml streptomycin (GIBCO #15140-122) at 37° C. in 5% CO₂. Her-2 positive cell line media also contained 100×MEM Vitamins (Cellgro #25-020-C1)+50×MEM Amino Acids (Cellgro #25-030-C1)+100× Non-Essential Amino Acids (Hyclone # SH30238 (166777-186))+100 mM Sodium Pyruvate (Cellgro #25-000-C1)+1 M HEPES Buffer (VWR #45000-690)+2-Mercaptoethanol (Sigma # M3148). All cryoembedded frozen cell pellets gave excellent block cutting ease and retained 97-99% section morphology (determined by visual inspection, by fluorescent microscopy) compared to cultured cell morphology prior to embedding.

Morphology and target specificity were determined as follows. The pass rate across all slides must be 90% or better for each antibody. A slide passed if the staining intensity is acceptable/nonacceptable when compared to the positive and negative run controls on the same instrument run. For data analysis and determination of reproducibility (measured as % antibody reliability on RAJI cell pellet), there was an expected sample of 108 RAJI cell pellet slides (4 pellets×3 slides per pellet×3 BenchMark XT instruments×3 runs/XT). Assuming the acceptance criterion of 90% was exactly met, the lower bound of the one-sided 95% score confidence interval would be 84%. Thus, this sample size would provide 95% confidence that the true pass rate would be within 6% of the point estimate. Additionally, if the observed pass rate was 95%, a sample of 108 slides provided 95% confidence that the true pass rate is no lower than 90%. The sample size was determined sufficient for estimating the reproducibility of staining with the RAJI cell pellets.

### Example 2

### Cryoembedded Cell Pellet

RAJI cells were used to prepare a cryoembedded cell pellet for lupus kidney tissue because this cell line can express the complement components which can be used to test anti-complement antibodies.

Cells were grown to a total of 400−450×10⁶ cells and then harvested by centrifugation at a speed of 200 g for 5 minutes. The cells were then washed 2-3 times; each wash consisted of (a) centrifugation at 200 g for 5 minutes and then (b) resuspending the cells in serum-free media (RPMI Medium 1640, Gibco #21870). A final spin was performed at about 335 g for 4 minutes in a 15 ml polypropylene conical tube. This allows for an increase in cell concentration while limiting shearing effects. Transition to the next step was completed quickly (in less than 10 minutes) to minimize adverse structural or morphological degradation of the cells.

As much liquid as possible was removed from the tube by pipette, followed by flash freezing in liquid nitrogen (−190° C.) or isopentane/liquid nitrogen bath (−150° C.) without fixation. The cell pellet was then slightly thawed between two fingers, the tube was inverted and the cell pellet was extracted by rapping the opening of the tube on a hard surface. The frozen cell pellet was dislodged, placed in a cryomold, and covered with optimal cutting temperature cryoembedding medium, known as O.C.T. Compound. (TISSUE TEK®, cat. #4583) or simply OCT. The cryomold was placed in a cryostat chamber having a thermoelectric cooling device allowing heat extraction of the cryoembedded cell pellet until it was completely frozen. When the OCT turned completely white, the block was considered completely frozen. The cryomold containing the frozen cell pellet was wrapped in foil and transferred to −70° C. to −80° C. to cure for 1-3 days. The cryomold wrapped tightly in foil can be stored for up to 5 years. The cryoembedded frozen cell pellet is now ready to be sectioned.

Seven different RAJI, one MSH-2, and one Her-2 cryoembedded frozen cell pellets were analyzed in the following examples.

### Example 3

### Preparation of Sections from a Cryoembedded Cell Pellet

Cells were grown and a cryoembedded cell pellet was prepared according to Examples 1 and 2.

Sections were cut on a cryostat, Leica CM1850 (Leica Microsystems) with a high profile blade. Two to five micron sections were prepared. Section thickness depended on the quantity of components to be detected and fluorescent stain intensity as compared to the tissue being replaced by the current cryoembedded frozen cell pellet. Sections were placed on SuperFrost®/Plus Microslides (VWR, Cat #48311-703). Detection assays were performed on a Ventana XT instrument, therefore section placement was at the bottom ⅓ slide (this was to avoid section damage from reagent stream localization caused by the design of the instrument). However, if the assay is performed manually, sections can be placed in the middle of the slide. Slides were fixed in −20° C., pre-chilled Acetone (VWR, Cat. # BDH 1101-4LP) for about 8-10 minutes. Slides were either placed in an air tight container with Drierite (Fisher Scientific, Cat.# AC21752-5000) and desiccated for 30 minutes, or left at room temperature for 1 hour.

Sections were cut for use in detection with labeled anti-complement antibodies. Once cut, slides can be stored at −70° C. to −80° C. and used for up to 1 month.

### Example 4

### Complement Component Assay

Sections were prepared according to Example 3. Two micron sections were used for anti-C1q and five micron sections were used for anti-C3 and anti-C4. In the present example, complement detection was performed using a Ventana XT instrument. Therefore, the sections were placed at the bottom third of a SuperFrost®/Plus Microslides (VWR, Cat #48311-703) (placement should not be mid-slide because it may wash off). To fix the cryoembedded cell pellet, slides were immersed in acetone (at −20° C.) for 8-10 minutes. The sections were desiccated for a minimum of 30 minutes room temperature, or left at room temperature for 1 hour. Due to variations in chemical composition between different cell lines, some cell lines may require dessication (more thorough drying) while others only require air drying. If slides containing the sections were stored at −80° C. prior to detection, the slides were equilibrated to room temperature for about 20 minutes before use.

The sections were saturated two times with distilled H₂O for 10 minutes each at room temperature. From this point on, sections were not allowed to dry; slides were placed in a humidity chamber. Next, about 130 μl C6-depleted sera (Quidel, Cat. #502) was added directly on the section. Sera volume was optimized for the specific humidity chamber used. (If complement detection is to be performed on a Ventana XT instrument, it is advisable not to use a hydrophobic circle drawn, e.g., by a PAP Pen.).

Slides were then incubated for 30 minutes at about 4° C. followed by a wash for 10 minutes in Ventana Reaction Buffer (Ventana Medical Systems, Cat.#950-300) at room temperature. This reaction buffer is a Tris based buffer solution (pH 7.6±0.2) used to rinse slides providing a stable aqueous environment for immunohistochemistry or in situ hybridization. Any Tris based buffer solution with an appropriate pH may be used. The slides were then washed three times for five minutes each in distilled H₂O at room temperature.

The complement antibodies to be used in the detection were labeled with FITC according standard protocols. Slides were placed in a Ventana XT instrument and programs for FITC anti-C1q (760-2688), FITC anti-C3 (760-2686), or FITC anti-C4 (760-2687) were performed according to the manufacturer's protocol. After run completions, slides were washed thoroughly with distilled H₂O, Slides were then manually coversliped using ClearMount® with Pipes Buffer (Electron Microscopy Sciences, Cat. #17985-17). The bottle of ClearMount® was first held upside down for about 3 minutes to eliminate bubbles.

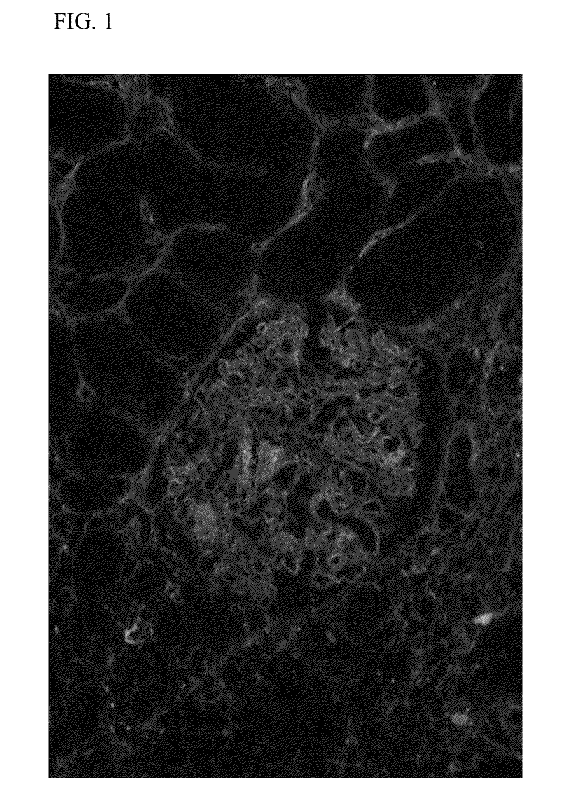

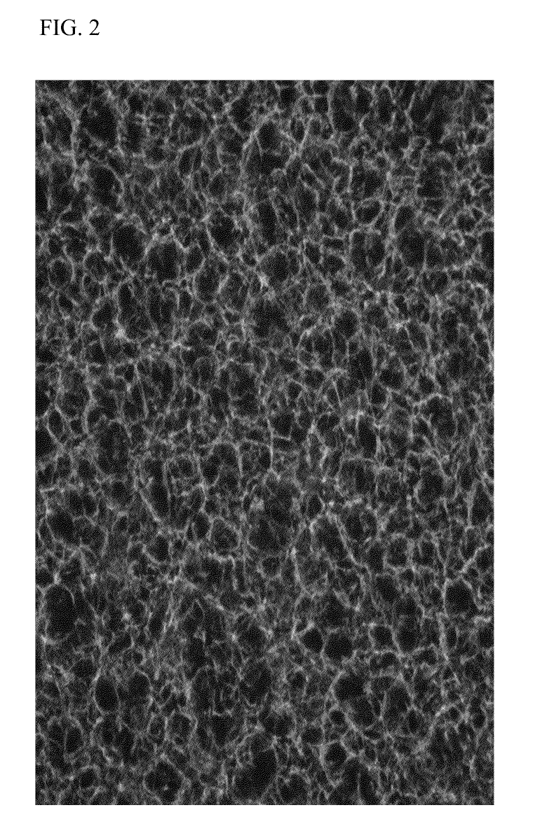

If automation is not available, the detection steps may be performed manually for this anti-C1q, anti-C3, and/or anti-C4 assay. The figures demonstrate the unexpected results achieved by preparing a RAJI cryoembedded cell pellet as described herein. As is evident upon comparing the RAJI cryoembedded cell pellet stained with FITC anti-C1q antibody of FIG. 2 with the similarly stained lupus kidney section of FIG. 1, the cryoembedded cell pellet maintains the ultrastructure and antigenicity of component cells. In addition, the figures show that the cryoembedded cell pellet maintains cellular morphology consistent with the lupus kidney section and therefore can be used as a tissue substitute, suitable for detection of targets of interest.

### Example 5

### Cryoembedded Cell Pellet Preparation for in Situ Hybridization—Prophetic Example

Cells are grown to a total of 400−450×10⁶ cells and harvested by centrifugation followed by washing 2-3 times in serum-free media and then once in PBS or saline. The cells are resuspended in 4% paraformaldehyde/0.1M sodium phosphate buffer, pH 7.4 at 4° C. for about 1 to 3 hours. The resuspended cells are spun at 380×g and are then resuspended in sterile 15% sucrose/1×PBS for about 3 hours to overnight at 4° C.

Cells are then centrifuged at about 380×g for about 4 minutes in a 15 ml polypropylene conical tube. This allows for an increase in cell concentration while limiting shearing effects. Transition to the next step is completed quickly (in less than 10 minutes) to prevent adverse structural or morphological degradation of the cells.

As much liquid as possible is removed from the tube by pipette, followed by flash freezing the cell pellet in liquid nitrogen or an isopentane/liquid nitrogen bath. Freezing will take about 1 minute signaled by the cell pellet turning white. Slightly thaw the cell pellet by rubbing the tube between two fingers, invert tube and extract the cell pellet by rapping the opening of the tube on a hard surface. The dislodged frozen cell pellet is placed in a cryomold, and covered with O.C.T. Compound (Tissue TEK, cat. #4583). The cryomold in frozen in liquid nitrogen. The bottom third (about) of the block is placed into the liquid nitrogen, and allowed to freeze until all but the center of the O.C.T. Compound is frozen. Freezing is concluded on dry ice (until the block turns completely white).

The cell pellet is then wrapped in foil and stored at −70° C. The pellet can be stored for several years without loss of mRNA signal. Blocks can desiccate if not properly wrapped causing the O.C.T. Compound to become difficult to cut.

### Example 6

### Preparation of Sections from a Cryoembedded Cell Pellet Prepared for In Situ Hybridization—Prophetic Example

Remove blocks from −70° C. and allow them to equilibrate with the cryostat chamber temperature.

It is preferable to use SuperFrost®/Plus positively charged microscope slides (e.g., Fisherbrand, Cat. #12-550-15) as utilization results in better section retention necessary for in situ hybridization.

Sections are cut to a thickness of about 5 to about 7 microns, mounted onto room temperature slides and immediately refrozen by placing slides with the sections into a slide box with a single Humi-Cap desiccant capsule (United Desiccants, Cat. #245-2). Slides are stored in the box at −80° C. These sections are stable for in situ hybridization and immunohistochemistry for most antigens for about 5 years.

### Example 7

### In Situ Hybridization Assay Utilizing Cryoembedded Cell Pellet Sections—Prophetic Example

Remove slides/sections from freezer and thaw for 5 mins. at 55° C. Fix 10 min. in 4% paraformaldehyde, 4° C. Wash 5 mins. in 0.5× saline-sodium citrate (SSC), room temperature. Immerse slides in proteinase K solution (1-5 μg/ml in RNase Buffer) for 10 min., room temperature. The amount of proteinase K should be optimized with each new preparation. Wash for 10 min. in 0.5×SSC, room temperature.

Prehybridization: Dry around sections with a paper wipe and lay slides flat in an air tight box with a piece of filter paper which has been saturated with 4×SSC, 50% formamide. Cover each section with 100 μl of hybridization buffer (10 mM dithiothreitol, dH₂O, 0.3M NaCl, 20 mM TRIS, pH 8.0, 5 mM EDTA, 1×Denhardt's, 10% Dextran Sulfate, 50% Formamide) without probe and incubate at 42° C. for 1-3 hours.

Hybridization Mix: Employing 100 μl prehybridization buffer, combine the following: 2.0 μl 35S-labeled riboprobe per slide (stock solution 300,000 cpm/μl in 1×TE), 1.0 μl tRNA per slide (50 mg/ml stock). TE is 10 mM Tris (bring to pH 8.0 with HCl) plus 1 mM EDTA. Heat 3 min., 95° C., immediately add 17.0 μl ice cold hybridization buffer per slide, vortex and place on ice.

Hybridization: Add 20 μl of the above hybridization mix to each 100 μl of prehybridization solution directly into the bubble covering the section. Incubate overnight at 55° C.

Wash 2 times, 10 min. each in 2×SSC with beta-mercaptoethanol-EDTA, room temperature. Immerse in RNase A solution (20 μg/ml in RNase buffer) 30 min., room temperature. Wash 2×SSC with beta-mercaptoethanol-EDTA, room temperature. Wash 2 hours in 4 liters of 0.1×SSC with beta-mercaptoethanol-EDTA, 55° C. Wash 2 times, 10 min. each in 0.5×SSC without beta-mercaptoethanol or EDTA, room temperature. Dehydrate 2 min. each in 50%, 70% and 90% ethanol containing 0.3M NH₄Ac. Dry in vacuum desiccator, 3-4 hours. Store with desiccant until autoradiography. Develop at 15° C.

The headings used in the disclosure are not meant to suggest that all disclosure relating to the heading is found within the section that starts with the heading. Disclosure for any subject may be found throughout the specification.

As used in the disclosure and the claims, the term “about” applies to all numeric values, whether or not explicitly indicated. The term “about” generally refers to a range of numbers that one would consider equivalent to the recited value (i.e., having the same function or result). In some instances, the term “about” may include numbers that are rounded to the nearest significant figure.

It is noted that terms like “preferably,” “commonly,” and “typically” are not used herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

As used in the disclosure, “a” or “an” means one or more than one, unless otherwise specified. As used in the claims, when used in conjunction with the word “comprising” the words “a” or “an” means one or more than one, unless otherwise specified. As used in the disclosure or claims, “another” means at least a second or more, unless otherwise specified. As used in the disclosure, the phrases “such as”, “for example”, and “e.g.” mean “for example, but not limited to” in that the list following the term (“such as”, “for example”, or “e.g.”) provides some examples but the list is not necessarily a fully inclusive list. The word “comprising” means that the items following the word “comprising” may include additional unrecited elements or steps; that is, “comprising” does not exclude additional unrecited steps or elements.

Detailed descriptions of one or more embodiments are provided herein. It is to be understood, however, that the present invention may be embodied in various forms. Therefore, specific details disclosed herein (even if designated as preferred or advantageous) are not to be interpreted as limiting, but rather are to be used as a basis for the claims and as a representative basis for teaching one skilled in the art to employ the present invention in any appropriate manner.

What is claimed is:

1. A method of preparing a cryoembedded cell concentrate, the method comprising:
washing cultured cells one or more times with a one or more wash solutions;
removing substantially all of the extracellular fluid, to provide a cell concentrate;
freezing the cell concentrate in less than about five minutes;
cryoembedding the frozen cell concentrate in an embedding medium, to provide the cryoembedded cell concentrate such that the ultrastructure and target specificity of the cells in the cryoembedded cell concentrate are substantially maintained, as compared to the cultured cells; and
optionally curing the cryoembedded cell concentrate.

2. The method of claim 1, wherein the cultured cells are RAJI cells, cells from an Her-2 positive cell line, or cells from an MSH2 positive cell line.

3. The method of claim 1, wherein one of the one or more washing cultured cells comprises
centrifuging the cultured cells at a speed of about 128 g to about 207 g,
removing the supernatant, and
resuspending the cultured cells in a wash solution.

4. The method of claim 1, wherein the removing comprises
centrifuging the cultured cells at a speed of about 335 g, and
extracting substantially all of the extracellular fluid by one or more pipetting steps.

5. The method of claim 1, wherein the cell concentrate is a cell pellet.

6. The method of claim 1, wherein freezing the cell concentrate comprises freezing at about −150° C. or freezing at about −190° C.

7. The method of claim 1, wherein freezing the cell concentrate comprises flash freezing.

8. The method of claim 1, wherein the time from beginning the step of removing substantially all of the extracellular fluid to freezing the cell concentrate is less than about 20 minutes.

9. The method of claim 1, wherein the time from beginning the step of removing substantially all of the extracellular fluid to freezing the cell concentrate is less than about 5 minutes.

10. The method of claim 1, wherein the curing occurs by placing the cryoembedded cell concentrate at about −80° C. for at least three days.

11. The method of claim 1, further comprising cutting the cryoembedded cell concentrate into sections suitable for viewing via light or fluorescent microscopy.

12. The method of claim 1, further comprising cutting the cryoembedded cell concentrate into sections retaining about 97% to about 99% section morphology that are suitable for viewing at no more than about 1,000× magnification.

13. The method of claim 1, wherein the viability of the cells is substantially maintained.

14. A cryoembedded cell concentrate prepared according to claim 1.

15. The cryoembedded cell concentrate of claim 14, wherein the cryoembedded cell concentrate is a tissue substitute for diagnostic methods.

16. A section prepared from a cryoembedded cell concentrate prepared according to claim 1.

17. The section of claim 16, wherein the section is fixed.

18. The section of claim 16, wherein the section has a thickness of about two microns or less.

19. A method for using a section of a cryoembedded cell concentrate prepared according to claim 1, the method comprising detecting ultrastructure, target specificity, or both, of the cells in the section.

20. The method of claim 19, wherein the detecting is accomplished using an immunocytochemical technique, using an immunohistochemical technique, using a hybridization technique, using a staining technique, or using an antibody to target a non-antigen.

21. The method of claim 19, wherein the detecting is accomplished using in situ hybridization or an antibody to target components of complement.

22. The method of claim 19, wherein the method is part of a diagnostic method for detecting disease in an animal.

23. The method of claim 19, wherein the method is part of a diagnostic method for detecting disease in an animal, and the section is used as a control.

24. A kit comprising a cryoembedded cell concentrate prepared according to claim 1.

25. The kit of claim 24, further comprising one or more of a reagent for detection, a stain, and a control sample for the cryoembedded cell concentrate.

26. The kit of claim 24, further comprising a control sample for the cryoembedded cell concentrate.

27. A method of preparing a cryoembedded cell concentrate, the method comprising:
washing cultured cells two to five times with a one or more wash solutions, and the final wash solution is a serum-free media, saline, or PBS and is different from the previous wash solution(s);
centrifuging the cultured cells at a speed of about 335 g;
extracting substantially all of the extracellular fluid by one or more pipetting steps, to provide a cell concentrate;
flash freezing the cell concentrate;
cryoembedding the frozen cell concentrate in an embedding medium, to provide the cryoembedded cell concentrate such that the ultrastructure and target specificity of the cells in the cryoembedded cell concentrate are substantially maintained, as compared to the cultured cells;
curing the cryoembedded cell concentrate, and
cutting the cryoembedded cell concentrate into sections, to provide sections that are not suitable for use with an electron microscope.
